(19) United States
(12) Patent Application Publication
(10) Pub. No.: US 2020/0065899 A1
(43) Pub. Date: Feb. 27, 2020

(54) ITEM MARKET PLACE IN BLOCKCHAIN ENVIRONMENT

(71) Applicant: GET IT FIRST, Inc., Malibu, CA (US)

(72) Inventors: Bernhard Fritsch, Malibu, CA (US); Seyedmohammadreza Hashemifesharaki, Playa Del Rey, CA (US)

(21) Appl. No.: 16/110,193

(22) Filed: Aug. 23, 2018

(51) Int. Cl. G06Q 40/04; G06Q 30/06; H04L 9/06

(52) U.S. Cl. CPC G06Q 40/04; G06Q 30/0619; H04L 2209/38; H04L 2209/56; H04L 9/0637

(57) ABSTRACT

Embodiments of the present inventions include a computer system that involves a blockchain exchange, wherein an operator of the blockchain exchange lists a token that is exchangeable for value on the blockchain exchange such that a user of the blockchain exchange has the ability to obtain ownership of the token in exchange for value, the token representing and secured by a asset of independent value through a contract that automatically executes when the users purchases the tokens, wherein, when the contract executes it creates an obligation of the operator to properly store the asset and insure the asset.

### FIELD OF THE INVENTIONS

Embodiments of the present inventions relate to providing goods into a blockchain-based market place.

### BACKGROUND OF THE INVENTIONS

Crypto currencies are maintained and exchanged in a blockchain environment. Crypto currencies can have significant value to holders and to people making exchanges for value or for goods and services. The typical crypto currency marketplace relies on an apparent value based on others desire to participate in the marketplace as there is no government or material value underlying the crypto currency. There exists a need to improve such marketplaces.

### SUMMARY

Aspects of the present invention relate to a computer system that uses a blockchain exchange that is adapted to facilitate the fast, secure and reliable sale of assets of independent value. These innovations can create an environment where users feel comfortable and confident in making an automated purchase, without actually interacting with the owner/possessor of the physical item or negotiating with a third party for the purchase, of a valuable and potentially expensive and appreciable asset.

Embodiments include computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

Embodiments include such systems, methods, computer products, etc. that perform the steps of receiving at a blockchain exchange from a product selling user, through an online computer connection, a smart contract adapted to automatically cause a transaction to be consummated based on pre-determined conditions from a second user being met, wherein the smart contract represents an item of independent value, in the possession of the product selling user, of limited availability that is expected to increase in value over time, the item being identified in the smart contract by a specific identifier. The system may than associate the smart contract with the blockchain exchange accessible through a token such that a participating user of the blockchain exchange can purchase the token, wherein the participating user can hold the token, causing the product selling user to hold the item, or cause the smart contract to automatically execute to cause ownership of the item to transfer to the participating user. The system may then require the product selling user to store the item in accordance with the smart contract until the participating user, or subsequent buyer of the token from the participating user, requests to redeem the item, wherein the token is exchangeable on the blockchain exchange to the subsequent buyer until the redemption request is made. The system may further cause an insurance policy for coverage of the value of the item to become effective upon the smart contract's first activation, as indicated when the participating user buys the token.

Embodiments include such systems, methods, computer products, etc. that includes a blockchain exchange, wherein an operator of the blockchain exchange lists a token that is exchangeable for value on the blockchain exchange such that a user of the blockchain exchange has the ability to obtain ownership of the token in exchange for value, the token representing and secured by an asset of independent value through a contract that automatically executes when the users purchases the tokens, wherein, when the contract executes it creates an obligation of the operator to properly store the asset and insure the asset. The system may involve the operator of the blockchain exchange entering into an option agreement to purchase the asset prior to listing the token on the blockchain exchange. The system may involve the operator of the blockchain exchange listing the token only for a period of time for which the purchase option is valid. The system may involve the operator of the blockchain exchange causes the option to be satisfied and to take ownership of the asset in response to the token being exchanged for value on the blockchain exchange. The system may involve the exchange for value is based on a crypto-currency. The system may involve the exchange for value is based on a trade of a crypto-currency. The system may involve the exchange for value is based on a government-backed currency. The system may involve the user, following the exchange for value, holding the token such that the user can further trade the token for further value. The system may involve the user further trading the token on the blockchain operated by the operator. The system may involve the user further trades the token on a different blockchain exchange. The system may involve the user, following the exchange for value, making a redemption request that causes the physical item to be transferred to the user.

These and other embodiments, teachings, equivalents, etc. will become apparent upon reading the entire specification and such embodiments, teachings, suggestions, equivalents are intended to be captured by the principles of the present inventions.

### BRIEF DESCRIPTION OF THE FIGURES

Features and advantages of the claimed subject matter will be apparent from the following detailed descrip-tion of embodiments consistent therewith, which description should be considered with reference to the accompanying drawings.

FIG. 1 illustrates a computer process for establishing a smart contract for a good or service in accordance with the principles of the present inventions.

FIG. 2 illustrates a computer process for a user to transact for the smart contract in accordance with the principles of the present inventions.

FIG. 3 illustrates a computer process for trading of tokens that are secured or otherwise represent a physical item or service of appreciating value in accordance with the principles of the present inventions.

FIG. 4 illustrates another trading example that does not involve a separate exchange such as Ethereum in accordance with the principles of the present inventions.

FIG. 5A illustrates a computer processes in accordance with the principles of the present inventions for the purchase of rights to a physical good through a blockchain exchange.

FIG. 5B illustrates a computer processes in accordance with the principles of the present inventions for the redemption of the physical asset through the blockchain exchange.

FIG. 6 illustrates a distributed computer network that is executing blockchain marketplace software in accordance with the principles of the present inventions.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION OF THE INVENTIONS

Aspects of the present inventions relate to associating goods or services that are estimated to increase in value with tokens in a crypto currency marketplace. High value goods or services that are rare or are otherwise provided with limited availability tend to maintain value and increase in value over time. Associating such goods or services with tokens that can be exchanged in a crypto currency market place can provide additional secured value to the tokens. For example, a luxury item (e.g. high-end liquor, high-end wine, real estate, rare automobiles, classic cars, antiques, flights, vacation packages, entertainment packages, apartment rentals, jewelry, copyrights in movies, music, games, art, etc.) may be associated with a smart contract (e.g. a self-executing agreement to transfer ownership of the item) that can be exchanged in a crypto currency type marketplace or in its own marketplace. In embodiments, the underlying technology is blockchain where the blockchain system causes the smart contract to execute once the predetermined conditions are met. In embodiments, the item may be exchanged for other tokens that are backed by other items. In embodiments, the item may be exchanged for crypto currency that is not secured by goods or services. In embodiments, the item's token is based in one exchange and a transaction for the token is completed in coordination with a different exchange. For example, the item may be in exchange A and a buyer may buy the item by exchanging BitCoin on the BitCoin exchange where the process facilitates the transaction between the separate exchanges.

In embodiments, the tokens on the blockchain exchange represent, and are secured, by a valuable item (also referred to as an “asset”), which could be a good or service. The asset is of independent value that could be sold in a separate market on its own. In embodiments, the asset is insured to create an additional layer of security for a seller, buyer, owner, etc. In embodiments, the asset may be a physical asset (e.g. car, wine, liquor, antiques, gold, silver, real estate). In embodiments, the asset may be an intangible asset (e.g. intellectual property, copyright, patent, trademark, a right in a movie or music). In embodiments, the token may represent a portion of an asset (e.g. a fractional ownership portion in an asset).

Another aspect of the present inventions relates to pre-ordering goods or services through the crypto currency marketplace. A buyer may go to an exchange and purchase tokens that are secured by the goods or services. Once the user buys, whether through government back money or crypto currency, a smart contract automatically executes to cause the user to have an option to exchange a token or several tokens for the good or service. The user can also sell the token to someone else that wants the good or service instead of exchanging the token for the good or service for himself.

Aspects of the present inventions relate to a computer system that uses a blockchain exchange that is adapted to facilitate the fast, secure and reliable sale of assets of independent value. These innovations can create an environment where users feel comfortable and confident in making an automated purchase, without actually interacting with the owner/possessor of the item or negotiating with a third party for the purchase, of a valuable and potentially expensive and appreciable physical good. A user of the systems described herein can be comfortable in making purchases, exchanges, trades, etc. automatically because the user can be assured at the security and reliability of the system and how the transactions are made. These technological advancements create an ability to transact at a speed and security never before seen.

Aspects of the present inventions relate to how a seller may participate in the blockchain marketplace for the sale of physical goods of value. A seller, for example, may own option contracts for the purchase of goods and the seller may sell a token on the blockchain exchange that represents the physical good. So long as the seller only posts the token for sale during his option period, he can effectively transfer title to the physical good to a buyer of the token on the exchange. In embodiments, the seller may be the operator of the exchange such that the operator is in control of all option contracts and tokens. This arrangement may make a very reliable marketplace because the owner can become a known operator of known reputation and reliability.

The operator of the blockchain exchange may, for example, enter into an option agreement to purchase the physical asset prior to listing the token on the blockchain exchange. The operator may have an option contract to buy gold, silver, wine, barrels of liquor, antiques, automobiles, etc. that give the operator the right to purchase the asset at a price during a period of time. During that period of time, the operator may list a token, representing the physical asset, on the blockchain such that a user of the blockchain marketplace can buy and then sell or exchange the token. The user buying the token is buying a token that is backed by and representing the asset. Once the buyer of the token buys the token, the operator may then buy the asset, or otherwise perform under his option agreement, to secure title to the asset. The operator, or other party (e.g. owner before the consummation of the option agreement), may cause the asset to be protected and insured in compliance with a smart contract that was associated with the purchased token. The token can then be exchanged, sold, held, etc. until a final buyer decides to redeem the asset. Redemption may involve shipping the asset to the final buyer, performing some additional tasks (e.g. bottling the liquor, and posting for sale the bottles), etc.

In embodiments, following the token being purchased and the operator executing his option agreement to secure title, the buyer of the token may exchange the token on the same or different exchange. For example, the buyer may exchange the token for another token on the same exchange where the other token represents a different item of value. Further, the buyer may exchange the token on a different exchange (e.g. Bitcoin) for a crypto-coin. Further, the buyer may exchange the token on an exchange for government-backed currency.

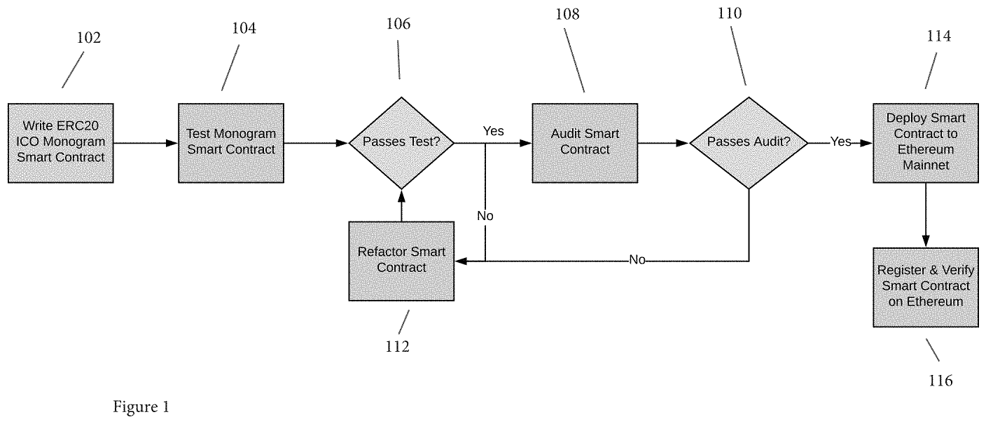

FIG. 1 illustrates a computer process for establishing a smart contract for a good or service in accordance with the principles of the present inventions. The smart contract will be written 102 to describe how a transaction for the good or service is to be executed in a blockchain based marketplace. The smart contract may be tested 104 to ensure that it will automatically execute as intended when a future transaction in the blockchain marketplace is completed. It the smart contract passes the test in step 104, it can be audited 110 and if it passes the audit, it can be deployed onto the blockchain based marketplace (e.g. through Ethereum). The smart contract can then be registered and verified on the exchange. In the event that the smart contract does not pass the test or audit, it may be reformed 112 for further processing.

The smart contract may identify a specific physical good, service, ticket, etc. The specifically identified item could be identified through a serial number or something similar that is meant to identify the specific item. For example, a bottle of wine may come with a specific serial number from the vineyard or post processing verification system such that the particular bottle of wine is directly associated with the smart contract and ownership can be transferred from one party to another by executing the smart contract. As another example, a vehicle may be identified in the smart contract by its vehicle identification number (VIN). A piece of real estate may be identified by a deed number or other information on the deed for the property. A barrel of wine, liquor, or other beverage may be identified by a serial number. There may also be situations where a group of items are identified by an identification code in the smart contract. A group of bottles of wine for example may be sold as a unit or secured as a unit and the group may have a single number that identifies them. The smart contract may also have requirements of how the item(s) are to be stored, protected and maintained to preserve the value of the items. Verification steps may also be required in the smart contract to ensure that they were properly stored, protected and maintained. In embodiments, sensor data that indicates that the item has been stored properly may be available and the sensor information may be added to the token that is secured by the smart contract. This ensures a secure record of the storage and maintenance of the item right with the token such that a buyer of the token can see the verified storage information. In embodiments, the storage information may be manually or automatically loaded into the token/blockchain associated with the token. In embodiments, a third party validation company may inspect the item, verify the condition of the item, and then load the inspection data into the blockchain system in association with the token.

In embodiments, the physical item may be a card (e.g. playing card, sports memorabilia card, gaming card, etc.) that has inherent value. In embodiments, the card carries additional value because it is associated with or signed by a famous person. The famous person's association or signature may be verified by a third party verification company and this verification may be loaded into the blockchain system in association with the token.

In embodiments, the item may be a ticket to an entertainment venue (e.g. sporting event, concert, theme park, etc.). The ticket may have a specific serial number or other identifying number or marking(s) and the number or marking may be stored in the blockchain in association with the token that is securing the smart contract. For example, a first user that owns a ticket to a sporting event may associate the ticket, with its serial number, with a smart contract. The smart contract may then be associated with the token on the blockchain such that the contract, and the underlying ticket, can be automatically executed to effect the ownership transfer of the verified ticket to a second user once certain pre-identified conditions that are identified in the smart contract are met.

Another aspect of the present inventions is that the smart contract and/or the underlying item of value may be insured. The insurance may be to protect that the specific item is verified, properly stored, not damaged, etc. The insurance may also be title insurance to insure the fact that the person representing ownership is in fact the true title owner. For example, if a smart contract is written to transfer ownership of a bottle of wine, the bottle of wine may be insured. The insurance policy number, or other identifier, may be written into the smart contract or otherwise associated with the token on the blockchain. Anyone interested in acquiring the bottle of wine through the system would then be able to see all the attributes of the insurance policy and see, securely, that is has been properly maintained.

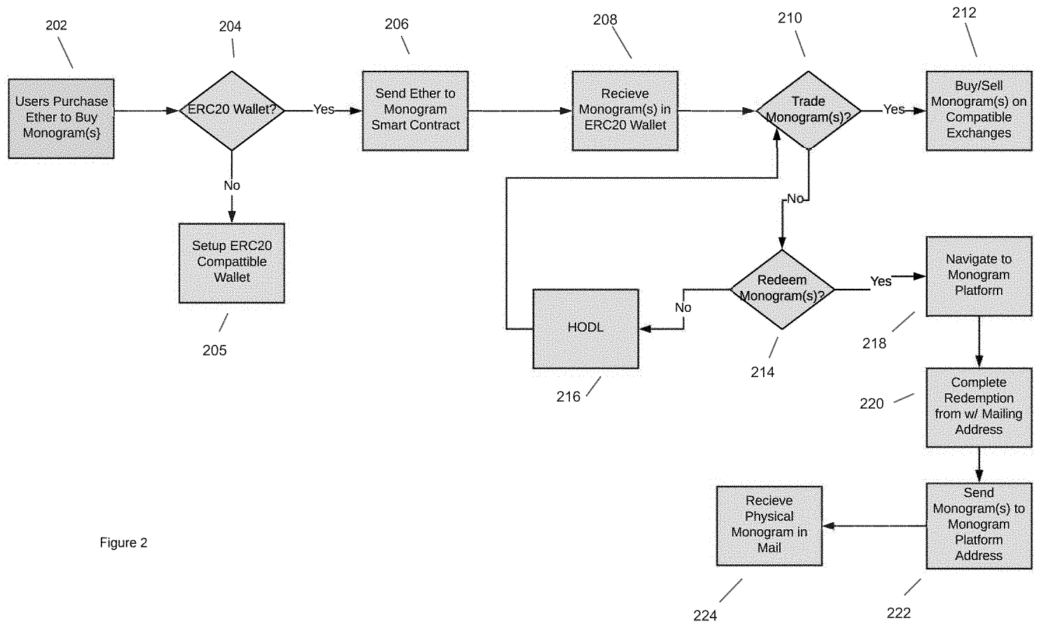

Once the smart contract is written and deployed on the blockchain based marketplace it can be executed by a user such that the user can either hold a token representing the good or service or the user can take possession of the good or service. FIG. 2 illustrates a computer process for a user to transact for the smart contract in accordance with the principles of the present inventions. A user wanting to by a token representing the good or service may start the process by buying into an exchange that is associated with the exchange with the desired token (e.g. buying a token on the Ethereum platform) 202, which may require a compatible wallet 205. If the user has the compatible wallet, determined at step 204, an Ethereum token may be sent to the exchange that maintains the smart contract for the item or service 206 to receive tokens from the target exchange 208. At this point in the process, the user may have the ability to trade the tokens that are associated with the smart contract 210, which can be done on compatible exchanges 212. The user may also choose to hold the token 216 or redeem the token for the good or service 214. If the user chooses to redeem the good or service, the user may navigate to the correct exchange, the one with the smart contract 218, complete the redemption process 220, send the exchanges tokens to the exchange 222, and receive the good or service at the designated mailing address or as otherwise specified 224.

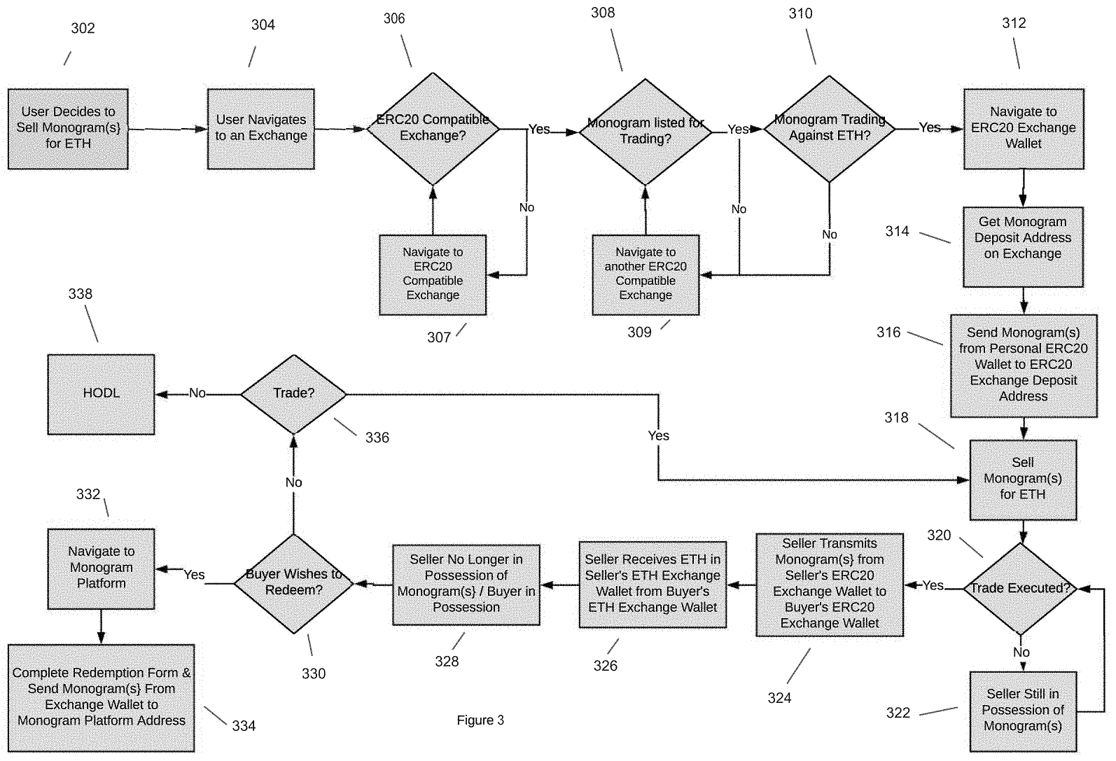

FIG. 3 illustrates a computer process for trading of tokens that are secured or otherwise represent a physical item or service of appreciating value in accordance with the principles of the present inventions. For simplicity of explanation here, a Monogram is being used as the name of the system or token that are secured or otherwise represent a physical item or service of appreciating value. An Eth is a token on a separate exchange and ERC is an Ethereum exchange. Of course, these are tradenames and are only being used to help the reader understand the example systems; the inventions are not limited to any specifically named exchange.

FIG. 3 begins with the user decided that she would like to sell her Monogram and she has decided to transact between the Monogram exchange and the Ethereum exchange 302. Of course, she could choose another compatible exchange if that were her desire. The user navigates to the trading exchange 304 and a check is done to see if the trading exchange is compatible with the Monogram exchange 306. If it is not, the system may re-direct the user to a compatible exchange. If the trading exchange is compatible, the Monogram token(s) are listed for trading on the trading exchange. If there is a problem listing the tokens, another check for compatibility 309 may be done. A further check of understanding if the trading exchange trades in Monograms may be done 310 to ensure not only exchange compatibility but also for trading acceptance/compatibility. Exchanges generally operate with the use of an exchange wallet, which is used in this example process. The user navigates to an ERC exchange wallet 312, obtains a deposit address for the Monogram on the exchange, and then sends the Monogram(s) from the user's personal wallet to the Ethereum exchange with the proper exchange deposit address 316. Now that the Monogram is listed on the ERC exchange, the user can decide to sell or trade the Monogram.

If no trade or sale is of interest to the user 320, the user may continue possession and ownership of the Monogram 322. If an acceptable trade or sale is found 320, the user can transmit the Monogram(s) from the user's ERC exchange wallet to a buyer's wallet 324. Then the user would receive ETH tokens in the user's wallet from the buyer's wallet 326. The user would then no longer be in possession of the Monogram(s) and the possession would have been transferred to the buyer 328.

With the buyer in possession of the Monogram token, the Buyer can decide if he would like to redeem the physical item or service associated with the Monogram 330. If he would like to make the redemption, he would navigate to the Monogram exchange 332 to complete a redemption process 334. The user would transfer the Monogram token at the Monogram exchange using the Monogram's exchange address 334.

In the event the buyer does not want to redeem to receive the physical item or service 330, he can decide to hold the tokens 338 or trade the tokens 336. An option would be to go back to the step 318 to effect a sale or trade.

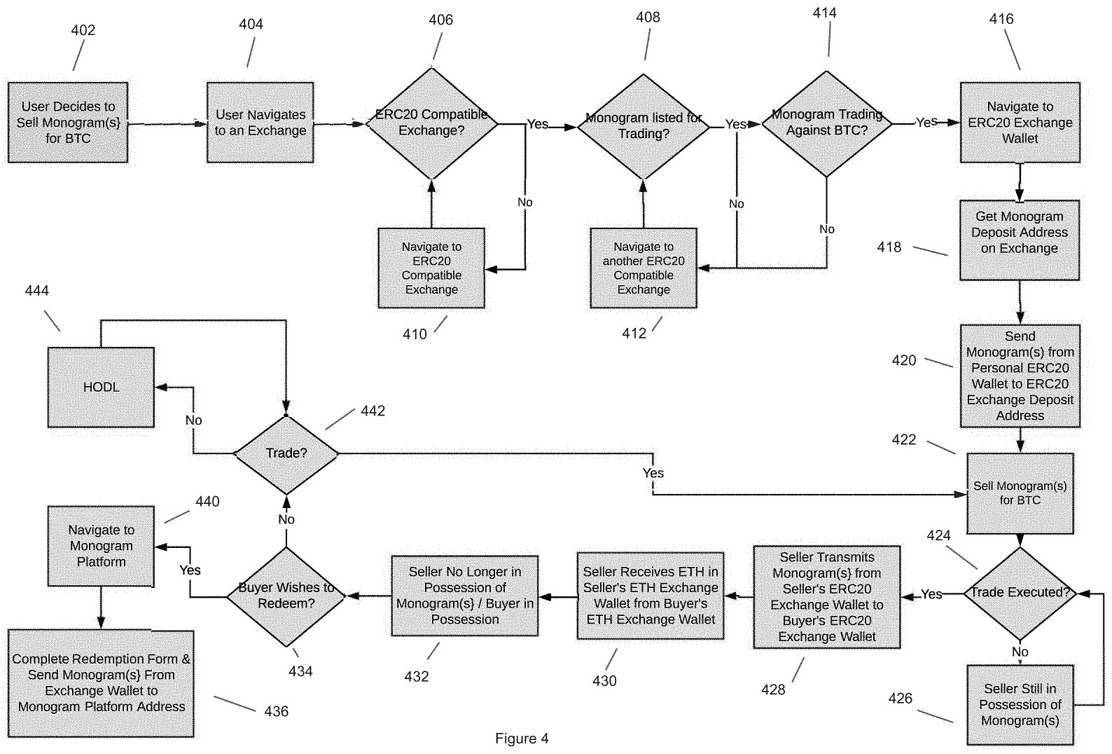

FIG. 4 illustrates another trading example that does not involve a separate exchange such as Ethereum in accordance with the principles of the present inventions. In this example, Monogram(s) are sold or traded in a crypto currency exchange such as Bitcoin or other crypto currency exchange. In this example, we are using the term BTC to represent the crypto currency.

FIG. 4 begins with the user decided that she would like to sell her Monogram and she has decided to transact between the Monogram exchange and the crypto currency exchange BTC 402. Of course, she could choose another compatible exchange if that were her desire. The user navigates to the trading exchange 404 and a check is done to see if the trading exchange is compatible with the Monogram exchange 406. If it is not, the system may re-direct the user to a compatible exchange 410. If the trading exchange is compatible, the Monogram token(s) are listed for trading on the trading exchange 408. If there is a problem listing the tokens, another check for compatibility 412 may be done. A further check of understanding if the trading exchange trades in Monograms may be done 414 to ensure not only exchange compatibility but also for trading acceptance/compatibility. Exchanges generally operate with the use of an exchange wallet, which is used in this example process. The user navigates to an ERC exchange wallet 416, obtains a deposit address for the Monogram on the exchange 418, and then sends the Monogram(s) from the user's personal wallet to the Ethereum exchange with the proper exchange deposit address 420. Now that the Monogram is listed on the ERC exchange, the user can decide to sell or trade the Monogram on the BTC 422.

If no trade or sale is of interest to the user 424, the user may continue possession and ownership of the Monogram 426. If an acceptable trade or sale is found 424, the user can transmit the Monogram(s) from the user's ERC exchange wallet to a buyer's wallet 428. Then the user would receive ETH tokens in the user's wallet from the buyer's wallet 430 The user would then no longer be in possession of the Monogram(s) and the possession would have been transferred to the buyer 432.

With the buyer in possession of the Monogram token, the Buyer can decide if he would like to redeem the physical item or service associated with the Monogram 434. If he would like to make the redemption, he would navigate to the Monogram exchange 440 to complete a redemption process 436. The user would transfer the Monogram token at the Monogram exchange using the Monogram's exchange address 334.

In the event the buyer does not want to redeem to receive the physical item or service 434, he can decide to hold the tokens 444 or trade the tokens 442. An option would be to go back to the step 422 to effect a sale or trade.

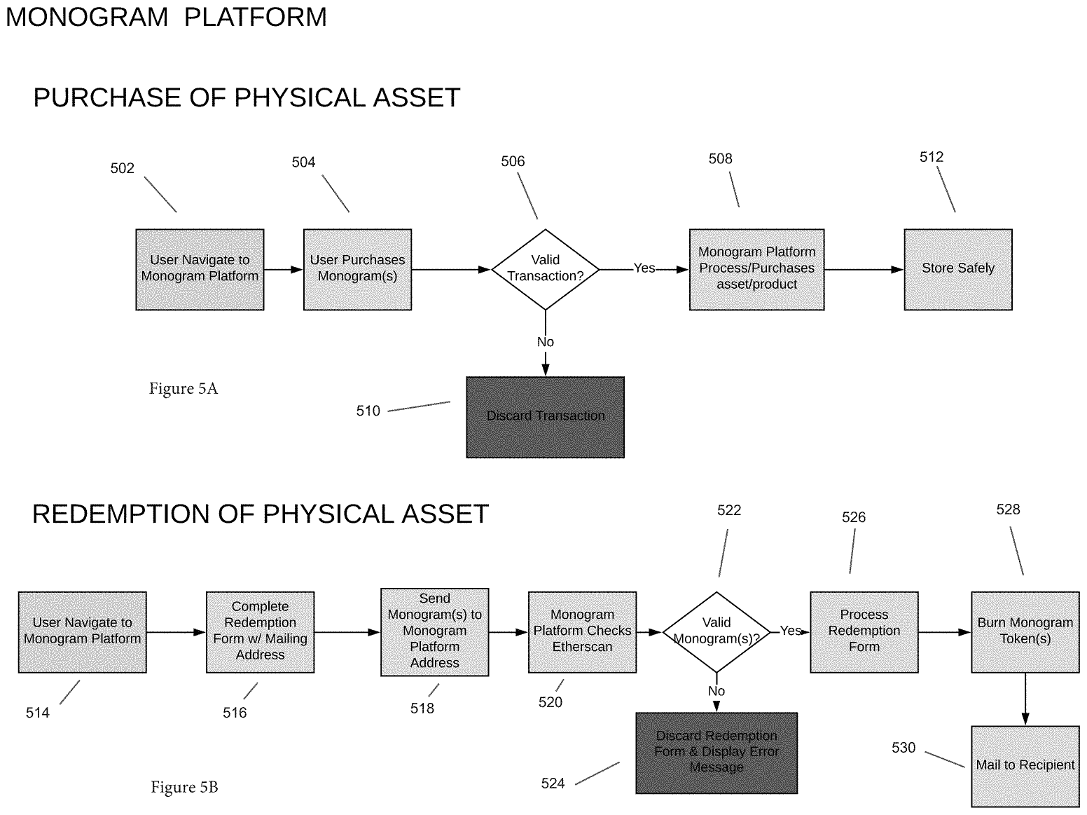

FIG. 5A illustrates a computer processes in accordance with the principles of the present inventions for the purchase of rights to a physical good through a blockchain exchange. FIG. 5B illustrates a computer processes in accordance with the principles of the present inventions for the redemption of the physical asset through the blockchain exchange. To purchase rights in a physical asset, the user may navigate to the blockchain exchange where one can buy tokens in exchange for rights in physical goods or services 502. The user may then purchase tokens that execute a smart contract to secure the user's rights in the physical asset 504. The transaction may be checked for validity 506 and if it is not valid the system could discard the transaction 510. If it is deemed a valid transaction the smart contract may self execute to purchase the rights in the product or service 508 and the product may be stored safely by a third party 512.

The user may redeem the physical item or service by navigating to the user may navigate to the blockchain exchange where one can buy tokens in exchange for rights in physical goods or services 514. The user may complete a redemption process with a physical mailing address where the goods or services are to be mailed or provided 516 and sending the token that is securing the physical item or service to the exchange 518. The exchange may perform checks to ensure it is a proper transaction 520. Non-valid transactions could be disregarded 524. Valid transactions could proceed to a redemption process 526. The tokens could be transacted and the physical goods could be delivered to the physical mailing address.

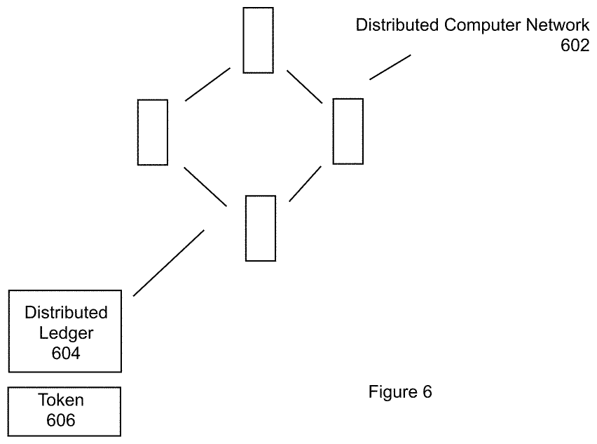

FIG. 6 illustrates a distributed computer network 602. A blockchain marketplace in accordance with the principles of the present inventions may be operated in such a distributed network 602. The blockchain marketplace may maintain a distributed ledger 604 to secure the transactions described herein. The token 606 may be exchanged on the distributed computer network 602 in the blockchain marketplace and transactions associated with the token 606 may be recorded in the distributed ledger.

The distributed computer network 602 may be a computer system whose components, such as hardware and software, are located on different networked computers, which then communicate and coordinate their actions by passing communications to and through each other. The components interact with each other in order to achieve a common goal. The distributed ledger 604 that is maintained on the distributed network 602 through the blockchain marketplace is one such common goal. Different computers and software components in different locations geographically, and even owned by different entities, may be used in the distributed computer network. Each separate computer device may have software that is intended to coordinate all of the necessary activities. The blockchain distributed ledger 604 then may become a publically accessible ledger with all of the blockchain security features.

A blockchain (otherwise referred to as a “block chain”) is a distributed database that maintains resources, e.g., a list of data records or the like. In embodiments, the resources may comprise financial information and/or resources, such as a designated portion of one or more financial accounts. The security of the resources maintained within a blockchain is enhanced by the distributed nature of the block chain. A blockchain typically includes several nodes, which may be one or more systems, machines, computers, data-bases, data stores or the like operably connected with one another. In some cases, each of the nodes or multiple nodes are maintained by different entities. A blockchain typically works without a central repository or single administrator. One well-known application of a block chain is the public ledger of transactions for cryptocurrencies such as used in Bitcoin. The data records recorded in the block chain are enforced cryptographically and stored on the nodes of the block chain.

A blockchain provides numerous advantages over traditional databases. A large number of nodes of a blockchain may reach a consensus regarding the validity of resources maintained with a block of the blockchain, e.g., a transaction contained on a transaction ledger, financial resources or the like. Additionally, when multiple versions of a resource, document or transaction exists on the ledger, multiple nodes can converge on the most up-to-date version of the trans-action. For example, in the case of a virtual currency transaction, any node within the block chain that creates a transaction can determine within a level of certainty whether the transaction can take place and become final by confirming that no conflicting transactions (i.e., the same currency unit has not already been spent) confirmed by the block chain elsewhere.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hard-wired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-RO Ms), compact disk rewritables (CD-RWs), and magneto-optical disks, semiconductor devices such as read-only memories (RO Ms), random access memo-ries (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be imple-mented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific inte-grated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this speci-fication are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions, which have been employed herein, are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

We claim:

1. A computer method, comprising:
receiving at a blockchain exchange from a product selling user, through an online computer connection, a smart contract adapted to automatically cause a transaction to be consummated based on pre-determined conditions from a second user being met, wherein the smart contract represents an item of independent value, in the possession of the product selling user, of limited availability that is expected to increase in value over time, the item being identified in the smart contract by a specific identifier;
associating the smart contract with the blockchain exchange accessible through a token such that a participating user of the blockchain exchange can purchase the token, wherein the participating user can hold the token, causing the product selling user to hold the item, or cause the smart contract to automatically execute to cause ownership of the item to transfer to the participating user; and
requiring the product selling user to store the item in accordance with the smart contract until the participating user, or subsequent buyer of the token from the participating user, requests to redeem the item, wherein the token is exchangeable on the blockchain exchange to the subsequent buyer until the redemption request is made; and
causing an insurance policy for coverage of the value of the item to become effective upon the smart contract's first activation, as indicated when the participating user buys the token.

2. A computer system, comprising:
a blockchain exchange, wherein an operator of the blockchain exchange lists a token that is exchangeable for value on the blockchain exchange such that a user of the blockchain exchange has the ability to obtain ownership of the token in exchange for value, the token representing and secured by a asset of independent value through a contract that automatically executes when the users purchases the tokens, wherein, when the contract executes it creates an obligation of the operator to properly store the asset and insure the asset.

3. The computer system of claim 2, wherein the operator of the blockchain exchange enters into an option agreement to purchase the asset prior to listing the token on the blockchain exchange.

4. The computer system of claim 3, wherein the operator of the blockchain exchange lists the token only for a period of time for which the purchase option is valid.

5. The computer system of claim 3, wherein the operator of the blockchain exchange causes the option to be satisfied and to take ownership of the asset in response to the token being exchanged for value on the blockchain exchange.

6. The computer system of claim 2, wherein the exchange for value is based on a crypto-currency.

7. The computer system of claim 2, wherein the exchange for value is based on a trade of a crypto-currency.

8. The computer system of claim 2, wherein the exchange for value is based on a government backed currency.

9. The computer system of claim 2, wherein the user, following the exchange for value, holds the token such that the user can further trade the token for further value.

10. The computer system of claim 9, wherein the user further trades the token on the blockchain operated by the operator.

11. The computer system of claim 9, wherein the user further trades the token on a different blockchain exchange.

12. The computer system of claim 2, wherein the user, following the exchange for value, makes a redemption request that causes the asset to be transferred to the user.
